(19) United States
(12) Patent Application Publication
(10) Pub. No.: US 2025/0015851 A1
(43) Pub. Date: Jan. 9, 2025

(54) TECHNIQUES FOR CODEBOOK SUBSET RESTRICTION FOR ADAPTIVE ANTENNA ARRAYS

(71) Applicant: QUALCOMM Incorporated, San Diego, CA (US)

(72) Inventors: Liangming WU, Beijing (CN); Jing DAI, Beijing (CN); Min HUANG, Beijing (CN); Chao WEI, Beijing (CN); Hao XU, Beijing (CN)

(21) Appl. No.: 18/716,442

(22) PCT Filed: Feb. 2, 2022
(86) PCT No.: PCT/CN2022/075307

§ 371 Date: Jun. 4, 2024

(51) Int. Cl. H04B 7/0456; H04B 7/06

(52) U.S. Cl. CPC H04B 7/0481; H04B 7/0691

(57) ABSTRACT

Aspects described herein relate to receiving a configuration indicating a first codebook subset restriction table restricting a set of precoding matrix indicators (PMIs) for which PMI feedback is to be reported for an antenna array, generating, based on the configuration, PMI feedback for an adaptive configuration of the antenna array based on a second codebook subset restriction table for the adaptive configuration of the antenna array, and transmitting the PMI feedback to the base station. Other aspects relate to transmitting the configuration and/or receiving the PMI feedback.

### BACKGROUND

Aspects of the present disclosure relate generally to wireless communication systems, and more particularly, to techniques for generating waveforms for wireless communications.

Wireless communication systems are widely deployed to provide various types of communication content such as voice, video, packet data, messaging, broadcast, and so on. These systems may be multiple-access systems capable of supporting communication with multiple users by sharing the available system resources (e.g., time, frequency, and power). Examples of such multiple-access systems include code-division multiple access (CDMA) systems, time-division multiple access (TDMA) systems, frequency-division multiple access (FDMA) systems, and orthogonal frequency-division multiple access (OFDMA) systems, and single-carrier frequency division multiple access (SC-FDMA) systems.

These multiple access technologies have been adopted in various telecommunication standards to provide a common protocol that enables different wireless devices to communicate on a municipal, national, regional, and even global level. For example, a fifth generation (5G) wireless communications technology (which can be referred to as 5G new radio (5G NR)) is envisaged to expand and support diverse usage scenarios and applications with respect to current mobile network generations. In an aspect, 5G communications technology can include: enhanced mobile broadband addressing human-centric use cases for access to multimedia content, services and data; ultra-reliable-low latency communications (URLLC) with certain specifications for latency and reliability; and massive machine type communications, which can allow a very large number of connected devices and transmission of a relatively low volume of non-delay-sensitive information.

Some wireless communication technologies, such as 5G NR, include functionality for network energy efficiency for environmental sustainability and reduction in operating costs. One such function is adaptive antenna array, which is efficient for reducing network power consumption, such as is low cell load scenarios. In adaptive antenna array, the number of antenna elements within the antenna array of a device can be modified to reduce energy emission and/or power consumption by the device.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

According to an aspect, a method for wireless communication at a user equipment (UE) is provided that includes receiving, from a base station, a configuration indicating a first codebook subset restriction table restricting a set of precoding matrix indicators (PMIs) for which PMI feedback is to be reported for an antenna array, generating, based on the configuration, PMI feedback for an adaptive configuration of the antenna array based on a second codebook subset restriction table for the adaptive configuration of the antenna array, and transmitting the PMI feedback to the base station.

In another aspect, a method for wireless communication at a network is provided that includes transmitting, to a UE, a configuration indicating a first codebook subset restriction table restricting a set of PMIs for which PMI feedback is to be reported for an antenna array, and receiving, from the UE, the PMI feedback for an adaptive configuration of the antenna array based on a second codebook subset restriction table for the adaptive configuration of the antenna array.

In a further example, an apparatus for wireless communication is provided that includes a transceiver, a memory configured to store instructions, and one or more processors communicatively coupled with the transceiver and the memory. The one or more processors are configured to execute the instructions to perform the operations of methods described herein. In another aspect, an apparatus for wireless communication is provided that includes means for performing the operations of methods described herein. In yet another aspect, a computer-readable medium is provided including code executable by one or more processors to perform the operations of methods described herein.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

The disclosed aspects will hereinafter be described in conjunction with the appended drawings, provided to illustrate and not to limit the disclosed aspects, wherein like designations denote like elements, and in which:

FIG. 1 illustrates an example of a wireless communication system, in accordance with various aspects of the present disclosure;

FIG. 2 is a block diagram illustrating an example of a user equipment (UE), in accordance with various aspects of the present disclosure;

FIG. 3 is a block diagram illustrating an example of a base station, in accordance with various aspects of the present disclosure;

FIG. 4 is a flow chart illustrating an example of a method for transmitting precoding matrix indicator (PMI) feedback based on a codebook subset restriction table obtained for an adaptive configuration of an antenna array, in accordance with aspects described herein;

FIG. 5 illustrates an example of an input codebook subset restriction table and possible output codebook subset restriction tables that are based on the input codebook subset restriction table, in accordance with aspects described herein;

FIG. 6 is a flow chart illustrating an example of a method for receiving PMI feedback based on a codebook subset restriction table for an adaptive configuration of an antenna array, in accordance with aspects described herein; and

FIG. 7 is a block diagram illustrating an example of a multiple-input multiple-output (MIMO) communication system including a base station and a UE, in accordance with various aspects of the present disclosure.

### DETAILED DESCRIPTION

Various aspects are now described with reference to the drawings. In the following description, for purposes of explanation, numerous specific details are set forth in order to provide a thorough understanding of one or more aspects. It may be evident, however, that such aspect(s) may be practiced without these specific details.

The described features generally relate to configuring codebook subset restrictions for adaptive antenna arrays in wireless communications. In wireless communication technologies, such as fifth generation (5G) new radio (NR), codebook subset restrictions can be configured to disable some UE feedback precoding matrix indicators (PMIs). For example, the PMIs indicated in the codebook subset restriction, which can be configured by a base station for the UE, can indicate PMIs for which feedback is not expected to be reported (e.g., to avoid interference to other UEs or cells). Type-1 codebook subset restriction can be provided by the following in 5G NR, as defined in third generation partnership project (3GPP) technical specification (TS) 38.214. The bitmap parameter n1-n2 can form the bit sequence α_{A}_{_{c}}₋₁, . . . α₁, α₀ where α₀ is the LSB and α_{A}_{_{c}}₋₁ is the MSB and where a bit value of zero can indicate that PMI reporting is not allowed to correspond to any precoder associated with the bit. The number of bits can be given by A_{c}=N₁N₂O₁O₂. Except when the number of layers v ∈{3,4} and the number of antenna ports is 16, 24, or 32, bit α_{N}_{₂}_{O}_{₂}ₗ₊ₘ can be associated with all precoders based on the quantity \hat{v}_{l,m}, l=0, . . . . N₁O₁−1, m=0, . . . N₂O₂−1. When the number of layers v ∈{3,4} and the number of antenna ports is 16, 24, or 32, bits α_{(N}_{₂}_{O}_{₂}_{(2l-1)+m)modN}_{₁}_{N}_{₂}_{O}_{₂}, α_{N}_{₂}_{O}_{₂}₍₂ₗ₎₊ₘ, and α_{N}_{₂}_{O}_{₂}₍₂ₗ₊₁₎₊ₘ can each be associated with all precoders based on the quantity \hat{v}_{l,m}, l=0, . . . . N₁O₁/2−1, m=0, . . . . N₂O₂/2−1, and if one or more of the associated bits is zero, then PMI reporting may not be allowed to correspond to any precoder based on \hat{v}_{l,m}.

In addition, in 5G NR for example, adaptive antenna arrays can be configured, as described, such that a device (e.g., a user equipment (UE)) can configure a portion of an antenna array for use in transmitting or receiving wireless communications. For example, the adaptive antenna arrays can be configured to deactivate some antenna elements, such as one or more rows or columns of antenna elements in the antenna array, to conserve signal energy emitted and/or resources utilized by the device in wireless communication. Adaptive antenna arrays can be efficient for reducing the network power consumption, such as in low cell load scenarios. To support adaptive antenna arrays, channel state information (CSI) report framework may be updated to support multiple codebook structure and feedback for a single CSI report. For example, the CSI report framework can support a reconfigurable number of antennas (e.g., N1, N2, which may relate to a number of columns or rows in an antenna array) for codebook. In another example, the CSI report framework can support a reconfigurable CSI-reference signal (RS). For the codebook supporting multiple N1, N2, the codebook subset restriction may be redesigned, as described herein. In one specific example, different N1, N2 values associated CSI report may be configured with different codebook subset restrictions.

In other examples, solutions to address the codebook subset restriction in adaptive array size can include correlated codebook subset restrictions for different antenna array sizes. In one example, a codebook subset restriction configuration (e.g., a configured bitmap or table, etc.) for one antenna array (e.g., a full array) can be reused for the adaptive antenna array. In another example, multiple codebook subset restriction configurations can be used for multiple antenna array sizes (and/or for deriving a codebook subset restriction configuration for a different antenna array size). Reusing one codebook subset restriction for multiple adaptive antenna array configurations, in this regard, can reduce signaling and complexity that may otherwise be required to configure codebook subset restrictions for each adaptive antenna array configuration. This can also improve the quality and/or efficiency of wireless communications between devices, which can also allow for conservation of communication resources, and/or can accordingly improve user experience when using a device (e.g., a user equipment (UE)).

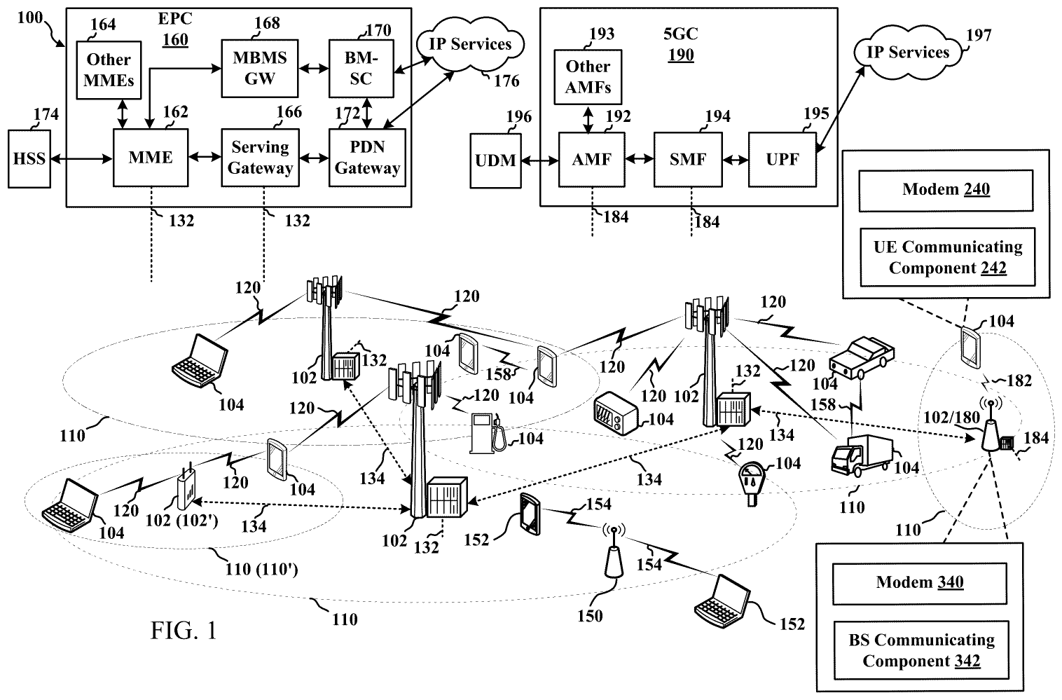

The described features will be presented in more detail below with reference to FIGS. 1-7.

As used in this application, the terms “component,” “module,” “system” and the like are intended to include a computer-related entity, such as but not limited to hardware, firmware, a combination of hardware and software, software, or software in execution. For example, a component may be, but is not limited to being, a process running on a processor, a processor, an object, an executable, a thread of execution, a program, and/or a computer. By way of illustration, both an application running on a computing device and the computing device can be a component. One or more components can reside within a process and/or thread of execution and a component can be localized on one computer and/or distributed between two or more computers. In addition, these components can execute from various computer readable media having various data structures stored thereon. The components can communicate by way of local and/or remote processes such as in accordance with a signal having one or more data packets, such as data from one component interacting with another component in a local system, distributed system, and/or across a network such as the Internet with other systems by way of the signal.

Techniques described herein may be used for various wireless communication systems such as CDMA, TDMA, FDMA, OFDMA, single carrier-FDMA, and other systems. The terms “system” and “network” may often be used interchangeably. A CDMA system may implement a radio technology such as CDMA2000, Universal Terrestrial Radio Access (UTRA), etc. CDMA2000 covers IS-2000, IS-95, and IS-856 standards. IS-2000 Releases 0 and A are commonly referred to as CDMA2000 1×, 1×, etc. IS-856 (TIA-856) is commonly referred to as CDMA2000 1×EV-DO, High Rate Packet Data (HRPD), etc. UTRA includes Wideband CDMA (WCDMA) and other variants of CDMA. A TDMA system may implement a radio technology such as Global System for Mobile Communications (GSM). An OFDMA system may implement a radio technology such as Ultra Mobile Broadband (UMB), Evolved UTRA (E-UTRA), IEEE 802.11 (Wi-Fi), IEEE 802.16 (WiMAX), IEEE 802.20, Flash-OFDM™, etc. UTRA and E-UTRA are part of Universal Mobile Telecommunication System (UMTS). 3GPP Long Term Evolution (LTE) and LTE-Advanced (LTE-A) are new releases of UMTS that use E-UTRA. UTRA, E-UTRA, UMTS, LTE, LTE-A, and GSM are described in documents from an organization named “3rd Generation Partnership Project” (3GPP). CDMA2000 and UMB are described in documents from an organization named “3rd Generation Partnership Project 2” (3GPP2). The techniques described herein may be used for the systems and radio technologies mentioned above as well as other systems and radio technologies, including cellular (e.g., LTE) communications over a shared radio frequency spectrum band. The description below, however, describes an LTE/LTE-A system for purposes of example, and LTE terminology is used in much of the description below, although the techniques are applicable beyond LTE/LTE-A applications (e.g., to fifth generation (5G) new radio (NR) networks or other next generation communication systems).

The following description provides examples, and is not limiting of the scope, applicability, or examples set forth in the claims. Changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in other examples.

Various aspects or features will be presented in terms of systems that can include a number of devices, components, modules, and the like. It is to be understood and appreciated that the various systems can include additional devices, components, modules, etc. and/or may not include all of the devices, components, modules etc. discussed in connection with the figures. A combination of these approaches can also be used.

FIG. 1 is a diagram illustrating an example of a wireless communications system and an access network 100. The wireless communications system (also referred to as a wireless wide area network (WWAN)) can include base stations 102, UEs 104, an Evolved Packet Core (EPC) 160, and/or a 5G Core (5GC) 190. The base stations 102 may include macro cells (high power cellular base station) and/or small cells (low power cellular base station). The macro cells can include base stations. The small cells can include femtocells, picocells, and microcells. In an example, the base stations 102 may also include gNBs 180, as described further herein. In one example, some nodes of the wireless communication system may have a modem 240 and UE communicating component 242 for obtaining a codebook subset restriction table for an adaptive antenna array configuration, in accordance with aspects described herein. In addition, some nodes may have a modem 340 and BS communicating component 342 for configuring another node to obtain a codebook subset restriction table for an adaptive antenna array configuration, in accordance with aspects described herein. Though a UE 104 is shown as having the modem 240 and UE communicating component 242 and a base station 102/gNB 180 is shown as having the modem 340 and BS communicating component 342, this is one illustrative example, and substantially any node or type of node may include a modem 240 and UE communicating component 242 and/or a modem 340 and BS communicating component 342 for providing corresponding functionalities described herein.

The base stations 102 configured for 4G LTE (which can collectively be referred to as Evolved Universal Mobile Telecommunications System (UMTS) Terrestrial Radio Access Network (E-UTRAN)) may interface with the EPC 160 through backhaul links 132 (e.g., using an SI interface). The base stations 102 configured for 5G NR (which can collectively be referred to as Next Generation RAN (NG-RAN)) may interface with 5GC 190 through backhaul links 184. In addition to other functions, the base stations 102 may perform one or more of the following functions: transfer of user data, radio channel ciphering and deciphering, integrity protection, head compression, mobility control functions (e.g., handover, dual connectivity), inter-cell interference coordination, connection setup and release, load balancing, distribution for non-access stratum (NAS) messages, NAS node selection, synchronization, radio access network (RAN) sharing, multimedia broadcast multicast service (MBMS), subscriber and equipment trace, RAN information management (RIM), paging, positioning, and delivery of warning messages. The base stations 102 may communicate directly or indirectly (e.g., through the EPC 160 or 5GC 190) with each other over backhaul links 134 (e.g., using an X2 interface). The backhaul links 134 may be wired or wireless.

The base stations 102 may wirelessly communicate with one or more UEs 104. Each of the base stations 102 may provide communication coverage for a respective geographic coverage area 110. There may be overlapping geographic coverage areas 110. For example, the small cell 102′ may have a coverage area 110′ that overlaps the coverage area 110 of one or more macro base stations 102. A network that includes both small cell and macro cells may be referred to as a heterogeneous network. A heterogeneous network may also include Home Evolved Node Bs (eNBs) (HeNBs), which may provide service to a restricted group, which can be referred to as a closed subscriber group (CSG). The communication links 120 between the base stations 102 and the UEs 104 may include uplink (UL) (also referred to as reverse link) transmissions from a UE 104 to a base station 102 and/or downlink (DL) (also referred to as forward link) transmissions from a base station 102 to a UE 104. The communication links 120 may use multiple-input and multiple-output (MIMO) antenna technology, including spatial multiplexing, beamforming, and/or transmit diversity. The communication links may be through one or more carriers. The base stations 102/UEs 104 may use spectrum up to Y MHz (e.g., 5, 10, 15, 20, 100, 400, etc. MHz) bandwidth per carrier allocated in a carrier aggregation of up to a total of Yx MHz (e.g., for x component carriers) used for transmission in the DL and/or the UL direction. The carriers may or may not be adjacent to each other. Allocation of carriers may be asymmetric with respect to DL and UL (e.g., more or less carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

In another example, certain UEs 104 may communicate with each other using device-to-device (D2D) communication link 158. The D2D communication link 158 may use the DL/UL WWAN spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, FlashLinQ, WiMedia, Bluetooth, ZigBee, Wi-Fi based on the IEEE 802.11 standard, LTE, or NR.

The wireless communications system may further include a Wi-Fi access point (AP) 150 in communication with Wi-Fi stations (STAs) 152 via communication links 154 in a 5 GHz unlicensed frequency spectrum. When communicating in an unlicensed frequency spectrum, the STAs 152/AP 150 may perform a clear channel assessment (CCA) prior to communicating in order to determine whether the channel is available.

The small cell 102′ may operate in a licensed and/or an unlicensed frequency spectrum. When operating in an unlicensed frequency spectrum, the small cell 102′ may employ NR and use the same 5 GHz unlicensed frequency spectrum as used by the Wi-Fi AP 150. The small cell 102′, employing NR in an unlicensed frequency spectrum, may boost coverage to and/or increase capacity of the access network.

A base station 102, whether a small cell 102′ or a large cell (e.g., macro base station), may include an eNB, gNodeB (gNB), or other type of base station. Some base stations, such as gNB 180 may operate in a traditional sub 6 GHz spectrum, in millimeter wave (mmW) frequencies, and/or near mmW frequencies in communication with the UE 104. When the gNB 180 operates in mmW or near mmW frequencies, the gNB 180 may be referred to as an mmW base station. Extremely high frequency (EHF) is part of the RF in the electromagnetic spectrum. EHF has a range of 30 GHz to 300 GHz and a wavelength between 1 millimeter and 10 millimeters. Radio waves in the band may be referred to as a millimeter wave. Near mmW may extend down to a frequency of 3 GHz with a wavelength of 100 millimeters. The super high frequency (SHF) band extends between 3 GHz and 30 GHz, also referred to as centimeter wave. Communications using the mmW/near mmW radio frequency band has extremely high path loss and a short range. The mmW base station 180 may utilize beamforming 182 with the UE 104 to compensate for the extremely high path loss and short range. A base station 102 referred to herein can include a gNB 180.

The EPC 160 may include a Mobility Management Entity (MME) 162, other MMEs 164, a Serving Gateway 166, a Multimedia Broadcast Multicast Service (MBMS) Gateway 168, a Broadcast Multicast Service Center (BM-SC) 170, and a Packet Data Network (PDN) Gateway 172. The MME 162 may be in communication with a Home Subscriber Server (HSS) 174. The MME 162 is the control node that processes the signaling between the UEs 104 and the EPC 160. Generally, the MME 162 provides bearer and connection management. All user Internet protocol (IP) packets are transferred through the Serving Gateway 166, which itself is connected to the PDN Gateway 172. The PDN Gateway 172 provides UE IP address allocation as well as other functions. The PDN Gateway 172 and the BM-SC 170 are connected to the IP Services 176. The IP Services 176 may include the Internet, an intranet, an IP Multimedia Subsystem (IMS), a PS Streaming Service, and/or other IP services. The BM-SC 170 may provide functions for MBMS user service provisioning and delivery. The BM-SC 170 may serve as an entry point for content provider MBMS transmission, may be used to authorize and initiate MBMS Bearer Services within a public land mobile network (PLMN), and may be used to schedule MBMS transmissions. The MBMS Gateway 168 may be used to distribute MBMS traffic to the base stations 102 belonging to a Multicast Broadcast Single Frequency Network (MBSFN) area broadcasting a particular service, and may be responsible for session management (start/stop) and for collecting eMBMS related charging information.

The 5GC 190 may include a Access and Mobility Management Function (AMF) 192, other AMFs 193, a Session Management Function (SMF) 194, and a User Plane Function (UPF) 195. The AMF 192 may be in communication with a Unified Data Management (UDM) 196. The AMF 192 can be a control node that processes the signaling between the UEs 104 and the 5GC 190. Generally, the AMF 192 can provide QoS flow and session management. User Internet protocol (IP) packets (e.g., from one or more UEs 104) can be transferred through the UPF 195. The UPF 195 can provide UE IP address allocation for one or more UEs, as well as other functions. The UPF 195 is connected to the IP Services 197. The IP Services 197 may include the Internet, an intranet, an IP Multimedia Subsystem (IMS), a PS Streaming Service, and/or other IP services.

The base station may also be referred to as a gNB, Node B, evolved Node B (eNB), an access point, a base transceiver station, a radio base station, a radio transceiver, a transceiver function, a basic service set (BSS), an extended service set (ESS), a transmit reception point (TRP), or some other suitable terminology. The base station 102 provides an access point to the EPC 160 or 5GC 190 for a UE 104. Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). IoT UEs may include machine type communication (MTC)/enhanced MTC (eMTC, also referred to as category (CAT)-M, Cat M1) UEs, NB-IoT (also referred to as CAT NB1) UEs, as well as other types of UEs. In the present disclosure, eMTC and NB-IoT may refer to future technologies that may evolve from or may be based on these technologies. For example, eMTC may include FeMTC (further eMTC), eFeMTC (enhanced further eMTC), mMTC (massive MTC), etc., and NB-IoT may include eNB-IoT (enhanced NB-IoT), FeNB-IoT (further enhanced NB-IoT), etc. The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology.

In an example, UE communicating component 242 can obtain a codebook subset restriction table for an adaptive antenna array configuration. For example, UE communicating component 242 can generate the codebook subset restriction table based on a codebook subset restriction table for a configuration of a different number of antennas (e.g., a table for a full antenna array), such to reduce signaling that may otherwise be required to specify codebook subset restriction tables for each possible adaptive configuration of the antenna array of the UE 104. In addition, in an example, BS communicating component 342 can configure the UE 104 to generate the codebook subset restriction table and/or can configure the UE 104 with the adaptive configuration for the antenna array, as described herein.

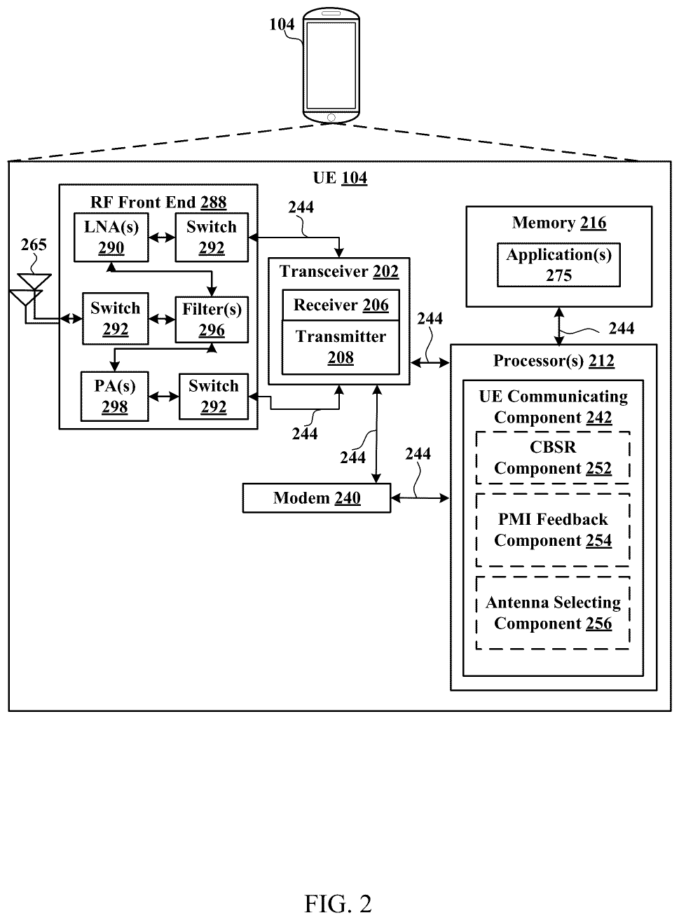

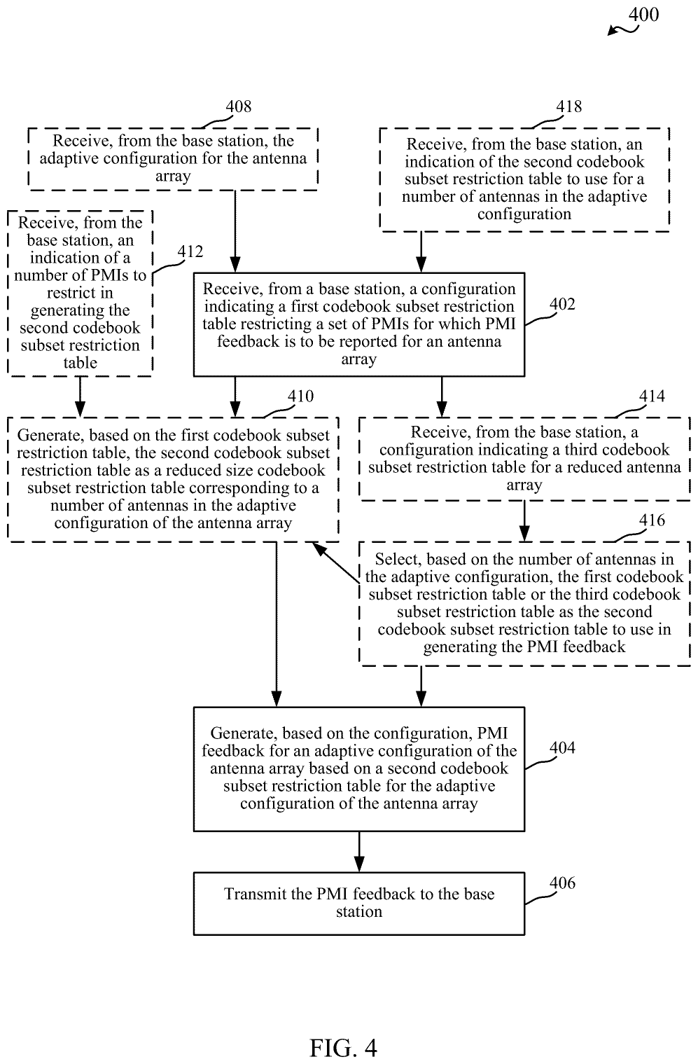

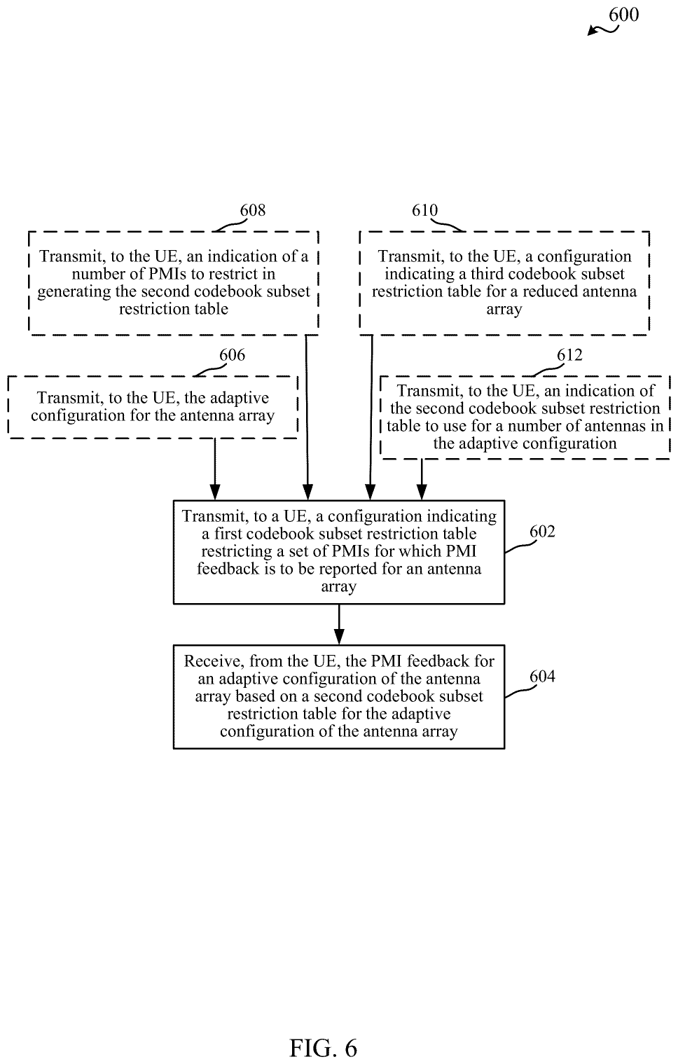

Turning now to FIGS. 2-7, aspects are depicted with reference to one or more components and one or more methods that may perform the actions or operations described herein, where aspects in dashed line may be optional. Although the operations described below in FIGS. 4 and 6 are presented in a particular order and/or as being performed by an example component, it should be understood that the ordering of the actions and the components performing the actions may be varied, depending on the implementation. Moreover, it should be understood that the following actions, functions, and/or described components may be performed by a specially programmed processor, a processor executing specially programmed software or computer-readable media, or by any other combination of a hardware component and/or a software component capable of performing the described actions or functions.

Referring to FIG. 2, one example of an implementation of UE 104 may include a variety of components, some of which have already been described above and are described further herein, including components such as one or more processors 212 and memory 216 and transceiver 202 in communication via one or more buses 244, which may operate in conjunction with modem 240 and/or UE communicating component 242 for obtaining a codebook subset restriction table for an adaptive antenna array configuration, in accordance with aspects described herein.

In an aspect, the one or more processors 212 can include a modem 240 and/or can be part of the modem 240 that uses one or more modem processors. Thus, the various functions related to UE communicating component 242 may be included in modem 240 and/or processors 212 and, in an aspect, can be executed by a single processor, while in other aspects, different ones of the functions may be executed by a combination of two or more different processors. For example, in an aspect, the one or more processors 212 may include any one or any combination of a modem processor, or a baseband processor, or a digital signal processor, or a transmit processor, or a receiver processor, or a transceiver processor associated with transceiver 202. In other aspects, some of the features of the one or more processors 212 and/or modem 240 associated with UE communicating component 242 may be performed by transceiver 202.

Also, memory 216 may be configured to store data used herein and/or local versions of applications 275 or UE communicating component 242 and/or one or more of its subcomponents being executed by at least one processor 212. Memory 216 can include any type of computer-readable medium usable by a computer or at least one processor 212, such as random access memory (RAM), read only memory (ROM), tapes, magnetic discs, optical discs, volatile memory, non-volatile memory, and any combination thereof. In an aspect, for example, memory 216 may be a non-transitory computer-readable storage medium that stores one or more computer-executable codes defining UE communicating component 242 and/or one or more of its subcomponents, and/or data associated therewith, when UE 104 is operating at least one processor 212 to execute UE communicating component 242 and/or one or more of its subcomponents.

Transceiver 202 may include at least one receiver 206 and at least one transmitter 208. Receiver 206 may include hardware, firmware, and/or software code executable by a processor for receiving data, the code comprising instructions and being stored in a memory (e.g., computer-readable medium). Receiver 206 may be, for example, a radio frequency (RF) receiver. In an aspect, receiver 206 may receive signals transmitted by at least one base station 102. Additionally, receiver 206 may process such received signals, and also may obtain measurements of the signals, such as, but not limited to, Ec/Io, signal-to-noise ratio (SNR), reference signal received power (RSRP), received signal strength indicator (RSSI), etc. Transmitter 208 may include hardware, firmware, and/or software code executable by a processor for transmitting data, the code comprising instructions and being stored in a memory (e.g., computer-readable medium). A suitable example of transmitter 208 may including, but is not limited to, an RF transmitter.

Moreover, in an aspect, UE 104 may include RF front end 288, which may operate in communication with one or more antennas 265 and transceiver 202 for receiving and transmitting radio transmissions, for example, wireless communications transmitted by at least one base station 102 or wireless transmissions transmitted by UE 104. RF front end 288 may be connected to one or more antennas 265 and can include one or more low-noise amplifiers (LNAs) 290, one or more switches 292, one or more power amplifiers (PAS) 298, and one or more filters 296 for transmitting and receiving RF signals.

In an aspect, LNA 290 can amplify a received signal at a desired output level. In an aspect, each LNA 290 may have a specified minimum and maximum gain values. In an aspect, RF front end 288 may use one or more switches 292 to select a particular LNA 290 and its specified gain value based on a desired gain value for a particular application.

Further, for example, one or more PA(s) 298 may be used by RF front end 288 to amplify a signal for an RF output at a desired output power level. In an aspect, each PA 298 may have specified minimum and maximum gain values. In an aspect, RF front end 288 may use one or more switches 292 to select a particular PA 298 and its specified gain value based on a desired gain value for a particular application.

Also, for example, one or more filters 296 can be used by RF front end 288 to filter a received signal to obtain an input RF signal. Similarly, in an aspect, for example, a respective filter 296 can be used to filter an output from a respective PA 298 to produce an output signal for transmission. In an aspect, each filter 296 can be connected to a specific LNA 290 and/or PA 298. In an aspect, RF front end 288 can use one or more switches 292 to select a transmit or receive path using a specified filter 296, LNA 290, and/or PA 298, based on a configuration as specified by transceiver 202 and/or processor 212.

As such, transceiver 202 may be configured to transmit and receive wireless signals through one or more antennas 265 via RF front end 288. In an aspect, transceiver may be tuned to operate at specified frequencies such that UE 104 can communicate with, for example, one or more base stations 102 or one or more cells associated with one or more base stations 102. In an aspect, for example, modem 240 can configure transceiver 202 to operate at a specified frequency and power level based on the UE configuration of the UE 104 and the communication protocol used by modem 240.

In an aspect, modem 240 can be a multiband-multimode modem, which can process digital data and communicate with transceiver 202 such that the digital data is sent and received using transceiver 202. In an aspect, modem 240 can be multiband and be configured to support multiple frequency bands for a specific communications protocol. In an aspect, modem 240 can be multimode and be configured to support multiple operating networks and communications protocols. In an aspect, modem 240 can control one or more components of UE 104 (e.g., RF front end 288, transceiver 202) to enable transmission and/or reception of signals from the network based on a specified modem configuration. In an aspect, the modem configuration can be based on the mode of the modem and the frequency band in use. In another aspect, the modem configuration can be based on UE configuration information associated with UE 104 as provided by the network during cell selection and/or cell reselection.

In an aspect, UE communicating component 242 can optionally include codebook subset restriction (CBSR) component 252 for obtaining a codebook subset restriction table for an adaptive configuration of an antenna array, a PMI feedback component 254 for reporting PMI feedback based on the codebook subset restriction table, and/or an antenna selecting component 256 for selecting a portion of antenna elements in an antenna array for wireless communications based on an adaptive configuration, in accordance with aspects described herein.

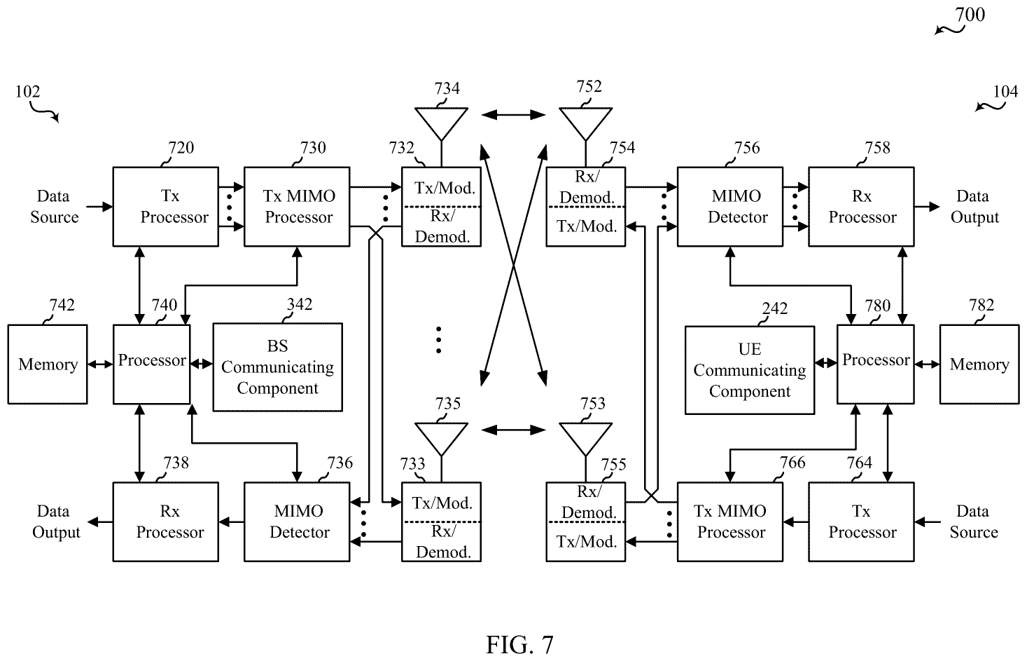

In an aspect, the processor(s) 212 may correspond to one or more of the processors described in connection with the UE in FIG. 7. Similarly, the memory 216 may correspond to the memory described in connection with the UE in FIG. 7.

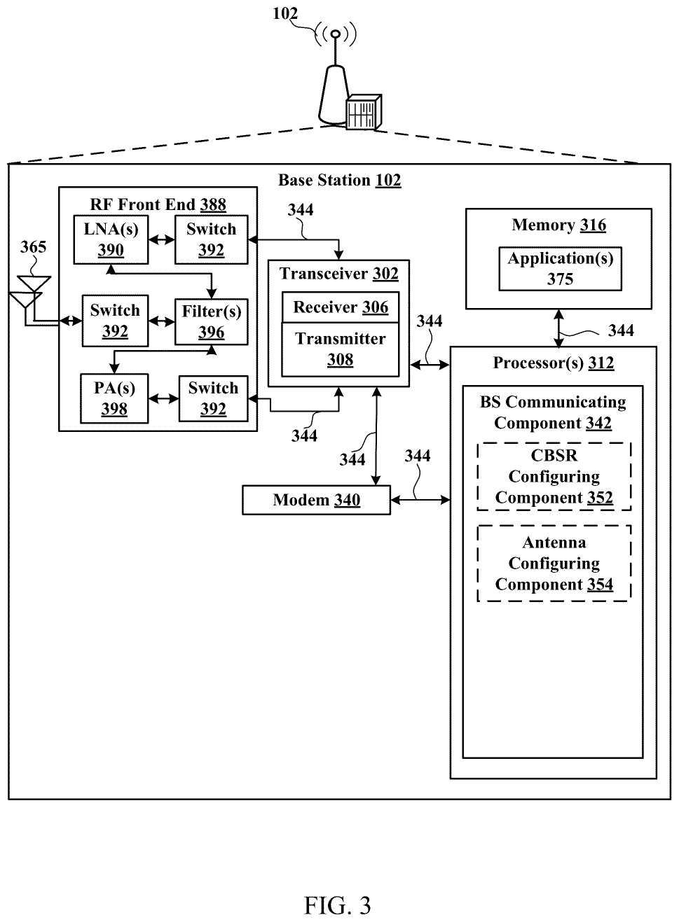

Referring to FIG. 3, one example of an implementation of base station 102 (e.g., a base station 102 and/or gNB 180, as described above) may include a variety of components, some of which have already been described above, but including components such as one or more processors 312 and memory 316 and transceiver 302 in communication via one or more buses 344, which may operate in conjunction with modem 340 and BS communicating component 342 for configuring another node to obtain a codebook subset restriction table for an adaptive antenna array configuration, in accordance with aspects described herein.

The transceiver 302, receiver 306, transmitter 308, one or more processors 312, memory 316, applications 375, buses 344, RF front end 388, LNAs 390, switches 392, filters 396, PAs 398, and one or more antennas 365 may be the same as or similar to the corresponding components of UE 104, as described above, but configured or otherwise programmed for base station operations as opposed to UE operations.

In an aspect, BS communicating component 342 can optionally include a CBSR configuring component 352 for configuring a node (e.g., a UE 104) with a codebook subset restriction table for a number of antenna elements in an antenna array, and/or an antenna configuring component 354 for providing the node (e.g., the UE 104) with an adaptive configuration for the antenna array to modify a number of antenna elements in the antenna array of the node (e.g., the UE 104) to be used for wireless communications, in accordance with aspects described herein.

In an aspect, the processor(s) 312 may correspond to one or more of the processors described in connection with the base station in FIG. 7. Similarly, the memory 316 may correspond to the memory described in connection with the base station in FIG. 7.

FIG. 4 illustrates a flow chart of an example of a method 400 for transmitting PMI feedback based on a codebook subset restriction table obtained for an adaptive configuration of an antenna array, in accordance with aspects described herein. In an example, a UE 104 can perform the functions described in method 400 using one or more of the components described in FIGS. 1 and 2.

In method 400, at Block 402, a configuration indicating a first codebook subset restriction table restricting a set of PMIs for which PMI feedback is to be reported for an antenna array can be received from a base station. In an aspect, CBSR component 252, e.g., in conjunction with processor(s) 212, memory 216, transceiver 202, UE communicating component 242, etc., can receive, from the base station (e.g., base station 102), the configuration indicating the first codebook subset restriction table restricting a set of PMIs for which PMI feedback is to be reported for an antenna array. For example, the first codebook subset restriction table may correspond to a full antenna array at the UE 104. In an example, CBSR component 252 may receive the first codebook subset restriction table in a configuration from the base station 102 using radio resource control (RRC) signaling, dynamic signaling, such as downlink control information (DCI), etc.

For example, the first codebook subset restriction table may include a table or bitmap where each bit can correspond to a PMI or precoder, as described above, where the bit value can indicate whether feedback is to be reported for the PMI or not. The number of bits in the first codebook subset restriction table can be given by N₁N₂O₁O₂ where N₁, N₂ is determined by the number of antenna in horizontal and vertical direction of the antenna array (e.g., the full antenna array at the UE 104), and 01, 02 indicates discrete Fourier transform (DFT) Oversampling. In an example, the first codebook subset restriction table for the full antenna array can be reused or otherwise adapted for an adaptive configuration of the antenna array.

In method 400, at Block 404, PMI feedback for an adaptive configuration of the antenna array can be generated based on a second codebook subset restriction table for the adaptive configuration of the antenna array. In an aspect, PMI feedback component 254, e.g., in conjunction with processor(s) 212, memory 216, transceiver 202, UE communicating component 242, etc., can generate, based on the configuration, PMI feedback for the adaptive configuration of the antenna array based on the second codebook subset restriction table for the adaptive configuration of the antenna array. As described above and further herein, PMI feedback component 254 can generate the PMI feedback based on the second codebook subset restriction table as being a different codebook subset restriction table than that received in the configuration (e.g., at Block 402), as being generated based on the first codebook subset restriction table received in the configuration (e.g., at Block 402), as determined between two or more codebook subset restriction tables received in one or more configurations from the base station 102, etc. In one example, obtaining the second codebook subset restriction table based on the first codebook subset restriction table or otherwise form a reduced number of codebook subset restriction tables than a number of possible adaptive configurations for the antenna array can reduce signaling for the codebook subset restriction tables.

In any case, for example, PMI feedback component 254 can report PMI feedback for PMIs indicated in the codebook subset restriction table as feedback to be reported (e.g., based on a corresponding bit in the table or bitmap having a value of 1), and/or can refrain from reporting PMI feedback for PMIs indicated in the codebook subset restriction table as feedback not to be reported (e.g., based on a corresponding bit in the table or bitmap having a value of 0). For example, each bit in the table or bitmap can correspond to at least one antenna element or configuration of antenna elements in an adaptive configuration for the antenna array of the UE 104, which may be configured by the base station 102.

In method 400, at Block 406, PMI feedback can be transmitted to the base station. In an aspect, PMI feedback component 254, e.g., in conjunction with processor(s) 212, memory 216, transceiver 202, UE communicating component 242, etc., can transmit the PMI feedback to the base station 102. For example, PMI feedback component 254 can transmit the restricted PMI feedback for the adaptive configuration of the antenna array using resources scheduled for the UE 104 by the base station, such as over physical uplink control channel (PUCCH) resources, physical uplink shared channel (PUSCH) resources, and/or the like.

In method 400, optionally at Block 408, the adaptive configuration for the antenna array can be received from the base station. In an aspect, antenna selecting component 256, e.g., in conjunction with processor(s) 212, memory 216, transceiver 202, UE communicating component 242, etc., can receive, from the base station (e.g., base station 102), the adaptive configuration for the antenna array. For example, the adaptive configuration can indicate a portion of antenna elements of the antenna array to be activated or deactivated in transmitting or receiving wireless communications, such to conserve signal energy emitted by the UE 104, reduce power consumption by the UE 104, etc. In an example, the adaptive configuration can indicate or modify a dimension or layer of antenna elements (e.g. indicate a reduction in a dimension of antenna elements) to be activated or deactivated. In an example, the adaptive configuration can indicate, or can facilitate determination of, N₁, N₂ parameters related to the codebook subset restriction, that are determined based on the number of antennas at the UE 104, or in this case, the number of antennas that are active at the UE 104 (which may be less than the full array based on the adaptive configuration). In one example, the adaptive configuration can reduce the value of N₁, N₂, or both.

In an example, the UE 104 can receive the adaptive configuration from the base station 102 or other node in RRC signaling, dynamic signaling, etc. In another example, UE 104 can generate the adaptive configuration for itself based on other parameters or detected conditions, such as a detected maximum permissible exposure (MPE) condition, an amount of signaling energy or resources to achieve a quality-of-service (QOS) in a detected radio environment, a power consumption desired for the UE 104 (e.g., where the UE is in a low power mode), etc. In any case, the adaptive configuration for the antenna array can indicate to use a number of antennas for wireless communications that is less than all antennas in the antenna array, and the UE 104 can determine a codebook subset restriction based on a number of antennas that are active in the adaptive configuration for the antenna array of the UE 104.

In method 400, optionally at Block 410, the second codebook subset restriction table can be generated, based on the first codebook subset restriction table, as a reduced size codebook subset restriction table corresponding to a number of antennas in the adaptive configuration of the antenna array. In an aspect, CBSR component 252, e.g., in conjunction with processor(s) 212, memory 216, transceiver 202, UE communicating component 242, etc., can generate, based on the first codebook subset restriction table, the second codebook subset restriction table as a reduced size codebook subset restriction table corresponding to the number of antennas in the adaptive configuration of the antenna array. For example, the UE 104 can receive the first codebook subset restriction table for the full antenna array, and CBSR component 252 can include functionality for determining the second codebook subset restriction table that is appropriate for the number of antenna elements that are active in the adaptive configuration of the antenna array based on the first codebook subset restriction table for the full antenna array.

In a specific example, the first codebook subset restriction table for the full array can be reused for the adaptive array. For example, a full array with (N₁,N₂,O₁,O₂)=(8,2,4,4) can be configured with a 256-bit table Type-I CBSR. To adapt to (N₁, N₂,O₁,O₂)=(4,2,4,4), no additional CBSR table may be needed or configured. Similarly, for Type-I single panel CSI report of rank 3 or rank 4 with >=16 ports, the codebook subset restriction table can be generated where bits α_{(N}_{₂}_{O}_{₂}_{(2l-1)+m)modN}_{₁}_{O}_{₁}_{N}_{₂}_{O}_{₂}, α_{N}_{₂}_{O}_{₂}₍₂ₗ₎₊ₘ, and α_{N}_{₂}_{O}_{₂}_{(2 l+1)+m} can each be associated with all precoders based on the quantity \hat{V}_{l,m}, l=0, . . . N₁O₁/2-1, m=0, . . . N₂O₂-1, as described above. In general, for example, beam index of l for a half size array beam forming can roughly create the beam direction with 2l for full size array. In one example, CBSR component 252 can disable beam 2l-1, 2l, and 2l+1 observed on full array, since the mainlobe of half size array is larger.

In another specific example, the full antenna array at the UE 104 can be configured with N₁′<N₁, N₂′<N₂ sized array, e.g., for N₁=16, N₁′=(2,4,6,8,12) can be possible. Considering the broadened main lobe with reduced N₁′, codebook restriction range can be adaptive to N₁′, as described herein, and CBSR component 252 can accordingly generate the second codebook subset restriction based on N₁′ (e.g., by adapting the first codebook subset restriction, which is for full N₁, to be for N₁′). In this example, CBSR component 252 can generate the second codebook subset restriction table to have a range of restricted beam indices for a reduced array size of N₁′ to be

$${l}^{′} = ⌊ \frac{{N}_{1}}{{N}_{1}^{′}} \times l - a ( \frac{{N}_{1}}{{N}_{1}^{′}} ) ⌋ \sim ⌈ \frac{{N}_{1}}{{N}_{1}^{′}} \times l + a ( \frac{{N}_{1}}{{N}_{1}^{′}} ) ⌉ .$$

Similarly, for example,

$${m}^{′} = ⌊ \frac{{N}_{2}}{{N}_{2}^{′}} \times m - a ( \frac{{N}_{2}}{{N}_{2}^{′}} ) ⌋ \sim ⌈ \frac{{N}_{2}}{{N}_{2}^{′}} \times m + a ( \frac{{N}_{2}}{{N}_{2}^{′}} ) ⌉ .$$

In this example, α(x) can be a changing parameter or a function for different

$$\frac{{N}_{1}}{{N}_{1}^{′}} ,$$

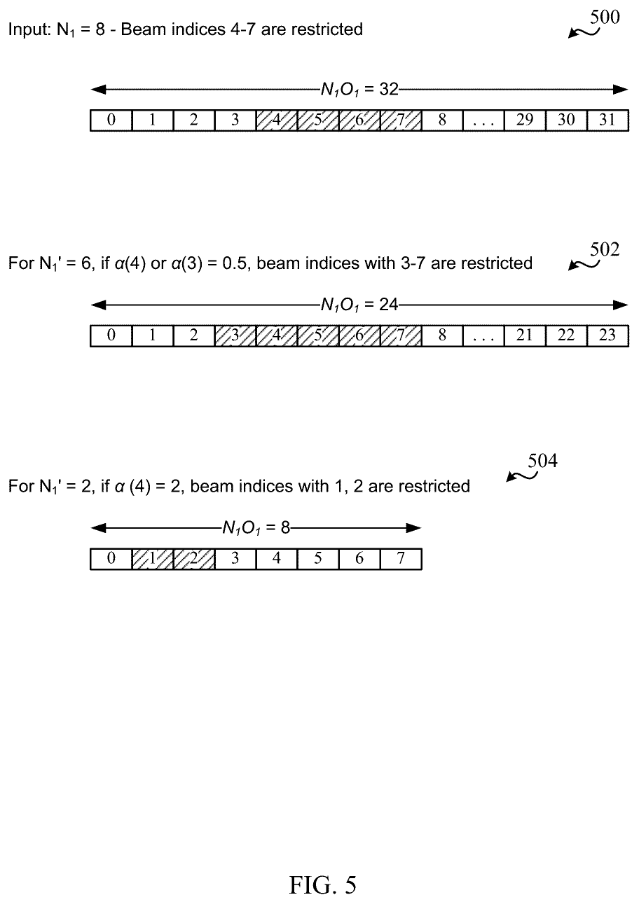

e.g., α(2)=1, α(3)=2, α(4)=3, etc. Where the antenna array at the UE 104 is a uniform planar array (UPA), for example, CBSR component 2523 can generate the beam via the Kronecker product of a two-dimension beams, where the beam restriction range that is associated with the full array beam range can be (N₂O₂×l′+m′ mod N₂O₂) mod N₁O₁N₂O₂ for all the associated l′ and m′ values. In this regard, more generally, CBSR component 252 can generate the second codebook subset restriction table at least in part by restricting a number of PMIs in the second codebook subset restriction table having a range of table index values that are a function of a second range of table index values of the first codebook subset restriction table corresponding to PMIs that are restricted in the first codebook subset restriction table. An example is shown in FIG. 5.

FIG. 5 illustrates an example of an input codebook subset restriction table 500 and possible output codebook subset restriction tables 502, 504, that are based on the input codebook subset restriction table 500. For example, the full antenna array at the UE 104 can be such that N₁=8. The input codebook subset restriction table 500, which can be the first codebook subset restriction table that is described above as received by the UE 104 in a configuration from the base station (e.g., at Block 402) can indicate that beam indices (or PMIs) 4-7 are restricted, such that the UE 104 (considering the full antenna array) is not to provide PMI feedback for beam indices 4-7, out of 0-31 beam indices. The UE 104 can receive an adaptive configuration for the antenna array that reduces the N₁ dimension from N₁=8 to N₁′=6. In this example, for a (4)=0.5 or a (3)=0.5, based on the formulas described above, CBSR component 252 can generate the second codebook subset restriction table as output codebook subset restriction table 502, based on the input codebook subset restriction table 500, as having beam indices 3-7 indicated as restricted out of 0-23 beam indices. In another example, the UE 104 can receive an adaptive configuration for the antenna array that reduces the N₁ dimension from N₁=8 to N₁′=2. In this example, for a (4)=2, based on the formulas described above, CBSR component 252 can generate the second codebook subset restriction table as output codebook subset restriction table 504, based on the input codebook subset restriction table 500, as having beam indices 1, 2 indicated as restricted out of 0-7 beam indices.

In method 400, optionally at Block 412, an indication of a number of PMIs to restrict in generating the second codebook subset restriction table can be received from the base station. In an aspect, CBSR component 252, e.g., in conjunction with processor(s) 212, memory 216, transceiver 202, UE communicating component 242, etc., can receive, from the base station 102, an indication of the number of PMIs to restrict in generating the second codebook subset restriction table. For example, CBSR component 252 can receive the indication in a configuration from the base station 102 (e.g., in the configuration received at Block 402 or another configuration), which may be via RRC signaling, dynamic signaling, etc., as described. For example, the indication may indicate a proportion of the ranges of the PMIs from the first codebook subset restriction table to be indicated as restricted in the second codebook subset restriction table. In an example, the indication may indicate the a value described above, which may include an indication of α(x) for various values of x. In any case, for example, CBSR component 252 can determine the ranges of PMIs to be indicated as restricted in the second codebook subset restriction table based on the indication and/or based on the formulas described above.

In another example, the base station 102 can indicate multiple codebook subset restriction tables, which can be less than the possible number of adaptive configurations for the antenna array, and CBSR component 252 can generate the second codebook subset restriction table, or otherwise determine the second codebook subset restriction table as, one of the multiple codebook subset restriction tables. Thus, in method 400, optionally at Block 414, a configuration indicating a third codebook subset restriction table for a reduced antenna array can be received from the base station. In an aspect, CBSR component 252, e.g., in conjunction with processor(s) 212, memory 216, transceiver 202, UE communicating component 242, etc., can receive, from the base station 102, a configuration indicating a third (and/or multiple other) codebook subset restriction tables for the (one or more) reduced antenna arrays. For example, CBSR component 252 can receive one or more configurations indicating one or more other codebook subset restriction tables for one or more values of one or more reduced antenna array dimensions (e.g., a codebook subset restriction table for N₁=8, N₁′=6, N₁′=2, etc.

In this example, in method 400, optionally at Block 416, the first codebook subset restriction table or the third codebook subset restriction table can be selected, based on the number of antennas (or antenna elements) in the adaptive configuration, as the second codebook subset restriction table to use in generating the PMI feedback. In an aspect, CBSR component 252, e.g., in conjunction with processor(s) 212, memory 216, transceiver 202, UE communicating component 242, etc., can select, based on the number of antennas (or antenna elements) in the adaptive configuration, the first codebook subset restriction table or the third codebook subset restriction table as the second codebook subset restriction table to use in generating the PMI feedback. For example, CBSR component 252 can select whichever one of the first or third (or additional) codebook subset restriction table that is associated with a number of antenna elements closest to (or closest to and greater than) that indicated in the adaptive configuration for the antenna array. In this example, CBSR component 252 can use the selected codebook subset restriction table as that for generating the PMI feedback, or based on which to generate the second codebook subset restriction table (e.g., using the formulas described above).

In a specific example, where multiples of CBSR table (N₁(1), N₂(1)), (N₁(2), N₂(2)) are configured in CSI report, and where ‘eight-two-TypeI-SinglePanel-Restriction’ is configured, ‘eight-two-TypeI-SinglePanel-Restriction’ (N₁(1), N₂(1)) and ‘two-two-TypeI-SinglePanel-Restriction’ (N₁(2), N₂(2)) can be configured. In this example, for N₁ (2)<N′<N₁ (1) and N₂(2)<N₂<N₂(1), CBSR component 252 can use the rules defined above associated with N₁(1) and N₂(1) to generate the second codebook subset restriction table. For N₁′<N₁(2) and N₂′<N₂(2), CBSR component 252 can use the rules defined above associated with N₁(2) and N₂(2) to generate the second codebook subset restriction table.

In yet another example, in method 400, optionally at Block 418, an indication of the second codebook subset restriction table to use for a number of antennas (or antenna elements) in the adaptive configuration can be received from the base station. In an aspect, CBSR component 252, e.g., in conjunction with processor(s) 212, memory 216, transceiver 202, UE communicating component 242, etc., can receive, from the base station 102, the indication of the second codebook subset restriction table to use for the number of antennas in the adaptive configuration. For example, CBSR component 252 can receive the indication of the second codebook subset restriction table as a bitmap, based on the number of antennas (or antenna elements) in the adaptive configuration for the antenna array, indicating the restricted beams (e.g., PMIs) for which feedback is not to be reported. PMI feedback component 254 can generate the PMI feedback based on this codebook subset restriction table in this example.

FIG. 6 illustrates a flow chart of an example of a method 600 for receiving PMI feedback based on a codebook subset restriction table for an adaptive configuration of an antenna array, in accordance with aspects described herein. In an example, a base station 102 can perform the functions described in method 600 using one or more of the components described in FIGS. 1 and 3.

In method 600, at Block 602, a configuration indicating a first codebook subset restriction table restricting a set of PMIs for which PMI feedback is to be reported for an antenna array can be transmitted to a UE. In an aspect, CBSR configuring component 352, e.g., in conjunction with processor(s) 312, memory 316, transceiver 302, BS communicating component 342, etc., can transmit, to the UE (e.g., UE 104), the configuration indicating the first codebook subset restriction table restricting the set of PMIs for which PMI feedback is to be reported for the antenna array of the UE. As described, for example, the first codebook subset restriction table can correspond to the full antenna array at the UE, such that the UE can generate, or otherwise determine or obtain, other codebook subset restriction tables for other adaptive configurations of the antenna array, as described above. For example, CBSR configuring component 352 can transmit the configuration in RRC signaling, dynamic signaling, etc. In one example, base station 102 can determine to restrict the PMIs for which feedback is to be reported to conserve signaling energy or power consumption at the UE 104 for one or more purposes (e.g., based on a detected event or radio conditions, based on request from the UE 104, etc.), and CBSR configuring component 352 can transmit the configuration based on this determination.

In method 600, at Block 604, the PMI feedback for an adaptive configuration of the antenna array can be received based on a second codebook subset restriction table for the adaptive configuration of the antenna array. In an aspect, BS communicating component 342, e.g., in conjunction with processor(s) 312, memory 316, transceiver 302, etc., can receive, from the UE (e.g., UE 104), the PMI feedback for the adaptive configuration of the antenna array of the UE, where the PMI feedback can be based on the second codebook subset restriction table for the adaptive configuration of the antenna array, or at least for a number of antennas (or antenna elements) configured in the adaptive configuration of the antenna array. For example, BS communicating component 342 can receive the PMI feedback over resources scheduled for uplink transmissions from the UE 104, such as PUCCH or PUSCH resources.

In method 600, optionally at Block 606, the adaptive configuration for the antenna array can be transmitted to the UE. In an aspect, antenna configuring component 354, e.g., in conjunction with processor(s) 312, memory 316, transceiver 302, BS communicating component 342, etc., can transmit, to the UE (e.g., UE 104), the adaptive configuration for the antenna array. For example, antenna configuring component 354 can transmit the adaptive configuration to the UE 104 using RRC signaling, dynamic signaling, etc. The adaptive configuration, as described, can indicate one or more antennas (or antenna elements), dimensions of antennas (or antenna elements), etc. to be activated or deactivated in performing wireless communications with the base station 102 and/or other devices.

In method 600, optionally at Block 608, an indication of a number of PMIs to restrict in generating the second codebook subset restriction table can be transmitted to the UE. In an aspect, CBSR configuring component 352, e.g., in conjunction with processor(s) 312, memory 316, transceiver 302, BS communicating component 342, etc., can transmit, to the UE (e.g., UE 104), the indication of the number of PMIs to restrict in generating the second codebook subset restriction table. For example, CBSR configuring component 352 can transmit the indication in RRC signaling or dynamic signaling. In an example, the indication can specify a proportion of the ranges of the PMIs from the first codebook subset restriction table to be indicated as restricted in the second codebook subset restriction table. In an example, the indication may indicate the a value described above, which may include an indication of α(x) for various values of x.

In another example, the base station 102 can indicate multiple codebook subset restriction tables, which can be less than the possible number of adaptive configurations for the antenna array. For example, in method 600, optionally at Block 610, a configuration indicating a third codebook subset restriction table for a reduced antenna array can be transmitted to the UE. In an aspect, CBSR configuring component 352, e.g., in conjunction with processor(s) 312, memory 316, transceiver 302, BS communicating component 342, etc., can transmit, to the UE (e.g., UE 104), the configuration indicating a third (and/or multiple other) codebook subset restriction tables for the (one or more) reduced antenna arrays. For example, CBSR configuring component 352 can transmit one or more configurations indicating one or more other codebook subset restriction tables for one or more values of one or more reduced antenna array dimensions (e.g., a codebook subset restriction table for N₁=8, N₁′=6, N₁′=2, etc., as described above.

In method 600, optionally at Block 612, an indication of the second codebook subset restriction table to use for a number of antennas in the adaptive configuration can be transmitted to the UE. In an aspect, CBSR configuring component 352, e.g., in conjunction with processor(s) 312, memory 316, transceiver 302, BS communicating component 342, etc., can transmit, to the UE, an indication of the second codebook subset restriction table to use for a number of antennas in the adaptive configuration. For example, CBSR configuring component 352 can transmit the indication of the second codebook subset restriction table as a bitmap, based on the number of antennas (or antenna elements) in the adaptive configuration for the antenna array, indicating the restricted beams (e.g., PMIs) for which feedback is not to be reported.

In an example, as described, the UE 104 can generate or determine the second codebook subset restriction table based on the first codebook subset restriction table (and/or the third or additional codebook subset restriction tables). In one example, CBSR configuring component 352 may similarly generate or determine the second codebook subset restriction table in order to process the PMI feedback, such as in order to determine for which PMIs PMI feedback is being reported. For example, CBSR configuring component 352 can generate the second codebook subset restriction table based on an indication of α(x) signaled to the UE 104, based on determining which of multiple codebook subset restriction tables to use as, or to use in generating, the second codebook subset restriction table, based on receiving an indication of the second codebook subset restriction table from the base station 102, etc.

FIG. 7 is a block diagram of a MIMO communication system 700 including a base station 102 and a UE 104. The MIMO communication system 700 may illustrate aspects of the wireless communication access network 100 described with reference to FIG. 1. The base station 102 may be an example of aspects of the base station 102 described with reference to FIG. 1. The base station 102 may be equipped with antennas 734 and 735, and the UE 104 may be equipped with antennas 752 and 753. In the MIMO communication system 700, the base station 102 may be able to send data over multiple communication links at the same time. Each communication link may be called a “layer” and the “rank” of the communication link may indicate the number of layers used for communication. For example, in a 2×2 MIMO communication system where base station 102 transmits two “layers,” the rank of the communication link between the base station 102 and the UE 104 is two.

At the base station 102, a transmit (Tx) processor 720 may receive data from a data source. The transmit processor 720 may process the data. The transmit processor 720 may also generate control symbols or reference symbols. A transmit MIMO processor 730 may perform spatial processing (e.g., precoding) on data symbols, control symbols, or reference symbols, if applicable, and may provide output symbol streams to the transmit modulator/demodulators 732 and 733. Each modulator/demodulator 732 through 733 may process a respective output symbol stream (e.g., for OFDM, etc.) to obtain an output sample stream. Each modulator/demodulator 732 through 733 may further process (e.g., convert to analog, amplify, filter, and upconvert) the output sample stream to obtain a DL signal. In one example, DL signals from modulator/demodulators 732 and 733 may be transmitted via the antennas 734 and 735, respectively.

The UE 104 may be an example of aspects of the UEs 104 described with reference to FIGS. 1-2. At the UE 104, the UE antennas 752 and 753 may receive the DL signals from the base station 102 and may provide the received signals to the modulator/demodulators 754 and 755, respectively. Each modulator/demodulator 754 through 755 may condition (e.g., filter, amplify, downconvert, and digitize) a respective received signal to obtain input samples. Each modulator/demodulator 754 through 755 may further process the input samples (e.g., for OFDM, etc.) to obtain received symbols. A MIMO detector 756 may obtain received symbols from the modulator/demodulators 754 and 755, perform MIMO detection on the received symbols, if applicable, and provide detected symbols. A receive (Rx) processor 758 may process (e.g., demodulate, deinterleave, and decode) the detected symbols, providing decoded data for the UE 104 to a data output, and provide decoded control information to a processor 780, or memory 782.

The processor 780 may in some cases execute stored instructions to instantiate a UE communicating component 242 (see e.g., FIGS. 1 and 2).

On the uplink (UL), at the UE 104, a transmit processor 764 may receive and process data from a data source. The transmit processor 764 may also generate reference symbols for a reference signal. The symbols from the transmit processor 764 may be precoded by a transmit MIMO processor 766 if applicable, further processed by the modulator/demodulators 754 and 755 (e.g., for single carrier-FDMA, etc.), and be transmitted to the base station 102 in accordance with the communication parameters received from the base station 102. At the base station 102, the UL signals from the UE 104 may be received by the antennas 734 and 735, processed by the modulator/demodulators 732 and 733, detected by a MIMO detector 736 if applicable, and further processed by a receive processor 738. The receive processor 738 may provide decoded data to a data output and to the processor 740 or memory 742.

The processor 740 may in some cases execute stored instructions to instantiate a BS communicating component 342 (see e.g., FIGS. 1 and 3).

The components of the UE 104 may, individually or collectively, be implemented with one or more ASICs adapted to perform some or all of the applicable functions in hardware. Each of the noted modules may be a means for performing one or more functions related to operation of the MIMO communication system 700. Similarly, the components of the base station 102 may, individually or collectively, be implemented with one or more application specific integrated circuits (ASICs) adapted to perform some or all of the applicable functions in hardware. Each of the noted components may be a means for performing one or more functions related to operation of the MIMO communication system 700.

The following aspects are illustrative only and aspects thereof may be combined with aspects of other embodiments or teaching described herein, without limitation.

Aspect 1 is a method for wireless communication at a UE including receiving, from a base station, a configuration indicating a first codebook subset restriction table restricting a set of PMIs for which PMI feedback is to be reported for an antenna array, generating, based on the configuration, PMI feedback for an adaptive configuration of the antenna array based on a second codebook subset restriction table for the adaptive configuration of the antenna array, and transmitting the PMI feedback to the base station.

In Aspect 2, the method of Aspect 1 includes receiving, from the base station, the adaptive configuration for the antenna array that indicates to use a number of antennas for wireless communications that is less than all antennas in the antenna array.

In Aspect 3, the method of Aspect 2 includes where the adaptive configuration indicates reduction of at least one of a first dimension, or a second dimension, of the antenna array.

In Aspect 4, the method of any of Aspects 1 to 3 includes where the second codebook subset restriction table includes a portion of the first codebook subset restriction table, where the portion is based on a number of antennas in the adaptive configuration of the antenna array.

In Aspect 5, the method of any of Aspects 1 to 4 includes generating, based on the first codebook subset restriction table, the second codebook subset restriction table as a reduced size codebook subset restriction table corresponding to a number of antennas in the adaptive configuration of the antenna array.

In Aspect 6, the method of Aspect 5 includes where generating the second codebook subset restriction table includes restricting a number of PMIs in the second codebook subset restriction table having a range of table index values that are a function of a second range of table index values of the first codebook subset restriction table corresponding to PMIs that are restricted in the first codebook subset restriction table.

In Aspect 7, the method of Aspect 6 includes receiving an indication of the number of PMIs in a configuration from the base station.

In Aspect 8, the method of any of Aspects 1 to 7 includes receiving, from the base station, a configuration indicating a third codebook subset restriction table restricting a set of PMIs for which PMI feedback is to be reported for a reduced antenna array, where generating the PMI feedback is based on selecting the first codebook subset restriction table or the third codebook subset restriction table for generating the second codebook subset restriction table based on a number of antennas in the adaptive configuration of the antenna array.

In Aspect 9, the method of any of Aspects 1 to 8 includes receiving, from the base station, an indication of the second codebook subset restriction table to use for a number of antennas in the adaptive configuration of the antenna array.

Aspect 10 is a method for wireless communication at a network including transmitting, to a UE, a configuration indicating a first codebook subset restriction table restricting a set of PMIs for which PMI feedback is to be reported for an antenna array, and receiving, from the UE, the PMI feedback for an adaptive configuration of the antenna array based on a second codebook subset restriction table for the adaptive configuration of the antenna array.

In Aspect 11, the method of Aspect 10 includes transmitting, to the UE, the adaptive configuration for the antenna array that indicates to use a number of antennas for wireless communications that is less than all antennas in the antenna array.

In Aspect 12, the method of Aspect 11 includes where the adaptive configuration indicates reduction of at least one of a first dimension, or a second dimension, of the antenna array.

In Aspect 13, the method of any of Aspects 10 to 12 includes where the second codebook subset restriction table is generated, based on the first codebook subset restriction table, as a reduced size codebook subset restriction table corresponding to a number of antennas in the adaptive configuration of the antenna array.

In Aspect 14, the method of any of Aspects 10 to 13 includes transmitting, to the UE an indication of the second codebook subset restriction table to use for a number of antennas in the adaptive configuration of the antenna array.

In Aspect 15, the method of any of Aspects 10 to 14 includes transmitting, to the UE, an indication of a number of one or more additional PMIs to disable in generating the second codebook subset restriction table, where the number of one or more additional PMIs corresponds to PMIs having a range of table index values that are a function of a second range of first table index values of the first codebook subset restriction table corresponding to PMIs that are restricted in the first codebook subset restriction table.

Aspect 16 is an apparatus for wireless communication including a transceiver, a memory configured to store instructions, and one or more processors communicatively coupled with the memory and the transceiver, where the one or more processors are configured to execute the instructions to cause the apparatus to perform any of the methods of Aspects 1 to 15.

Aspect 17 is an apparatus for wireless communication including means for performing any of the methods of Aspects 1 to 15.

Aspect 18 is a computer-readable medium including code executable by one or more processors for wireless communications, the code including code for performing any of the methods of Aspects 1 to 15.

The above detailed description set forth above in connection with the appended drawings describes examples and does not represent the only examples that may be implemented or that are within the scope of the claims. The term “example,” when used in this description, means “serving as an example, instance, or illustration,” and not “preferred” or “advantageous over other examples.” The detailed description includes specific details for the purpose of providing an understanding of the described techniques. These techniques, however, may be practiced without these specific details. In some instances, well-known structures and apparatuses are shown in block diagram form in order to avoid obscuring the concepts of the described examples.

Information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, computer-executable code or instructions stored on a computer-readable medium, or any combination thereof.

The various illustrative blocks and components described in connection with the disclosure herein may be implemented or performed with a specially programmed device, such as but not limited to a processor, a digital signal processor (DSP), an ASIC, a field programmable gate array (FPGA) or other programmable logic device, a discrete gate or transistor logic, a discrete hardware component, or any combination thereof designed to perform the functions described herein. A specially programmed processor may be a microprocessor, but in the alternative, the processor may be any conventional processor, controller, microcontroller, or state machine. A specially programmed processor may also be implemented as a combination of computing devices, e.g., a combination of a DSP and a microprocessor, multiple microprocessors, one or more microprocessors in conjunction with a DSP core, or any other such configuration.

The functions described herein may be implemented in hardware, software executed by a processor, firmware, or any combination thereof. If implemented in software executed by a processor, the functions may be stored on or transmitted over as one or more instructions or code on a non-transitory computer-readable medium. Other examples and implementations are within the scope and spirit of the disclosure and appended claims. For example, due to the nature of software, functions described above can be implemented using software executed by a specially programmed processor, hardware, firmware, hardwiring, or combinations of any of these. Features implementing functions may also be physically located at various positions, including being distributed such that portions of functions are implemented at different physical locations. Also, as used herein, including in the claims, “or” as used in a list of items prefaced by “at least one of” indicates a disjunctive list such that, for example, a list of “at least one of A, B, or C” means A or B or C or AB or AC or BC or ABC (i.e., A and B and C).

Computer-readable media includes both computer storage media and communication media including any medium that facilitates transfer of a computer program from one place to another. A storage medium may be any available medium that can be accessed by a general purpose or special purpose computer. By way of example, and not limitation, computer-readable media can comprise RAM, ROM, EEPROM, CD-ROM or other optical disk storage, magnetic disk storage or other magnetic storage devices, or any other medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include compact disc (CD), laser disc, optical disc, digital versatile disc (DVD), floppy disk and Blu-ray disc where disks usually reproduce data magnetically, while discs reproduce data optically with lasers. Combinations of the above are also included within the scope of computer-readable media.

The previous description of the disclosure is provided to enable a person skilled in the art to make or use the disclosure. Various modifications to the disclosure will be readily apparent to those skilled in the art, and the common principles defined herein may be applied to other variations without departing from the spirit or scope of the disclosure. Furthermore, although elements of the described aspects and/or embodiments may be described or claimed in the singular, the plural is contemplated unless limitation to the singular is explicitly stated. Additionally, all or a portion of any aspect and/or embodiment may be utilized with all or a portion of any other aspect and/or embodiment, unless stated otherwise. Thus, the disclosure is not to be limited to the examples and designs described herein but is to be accorded the widest scope consistent with the principles and novel features disclosed herein.

What is claimed is:

1. An apparatus for wireless communication, comprising:
a transceiver;
a memory configured to store instructions; and
one or more processors communicatively coupled with the memory and the transceiver, wherein the one or more processors are configured to:
receive, from a base station, a configuration indicating a first codebook subset restriction table restricting a set of precoding matrix indicators (PMIs) for which PMI feedback is to be reported for an antenna array;
generate, based on the configuration, PMI feedback for an adaptive configuration of the antenna array based on a second codebook subset restriction table for the adaptive configuration of the antenna array; and
transmit the PMI feedback to the base station.

2. The apparatus of claim 1, wherein the one or more processors are further configured to receive, from the base station, the adaptive configuration for the antenna array that indicates to use a number of antennas for wireless communications that is less than all antennas in the antenna array.

3. The apparatus of claim 2, wherein the adaptive configuration indicates reduction of at least one of a first dimension, or a second dimension, of the antenna array.

4. The apparatus of claim 1, wherein the second codebook subset restriction table includes a portion of the first codebook subset restriction table, wherein the portion is based on a number of antennas in the adaptive configuration of the antenna array.

5. The apparatus of claim 1, wherein the one or more processors are further configured to generate, based on the first codebook subset restriction table, the second codebook subset restriction table as a reduced size codebook subset restriction table corresponding to a number of antennas in the adaptive configuration of the antenna array.

6. The apparatus of claim 5, wherein the one or more processors are configured to generate the second codebook subset restriction table at least in part by restricting a number of PMIs in the second codebook subset restriction table having a range of table index values that are a function of a second range of table index values of the first codebook subset restriction table corresponding to PMIs that are restricted in the first codebook subset restriction table.

7. The apparatus of claim 6, wherein the one or more processors are further configured to receive an indication of the number of PMIs in a configuration from the base station.

8. The apparatus of claim 1, wherein the one or more processors are further configured to receive, from the base station, a configuration indicating a third codebook subset restriction table restricting a set of PMIs for which PMI feedback is to be reported for a reduced antenna array, wherein the one or more processors are configured to generate the PMI feedback based on selecting the first codebook subset restriction table or the third codebook subset restriction table for generating the second codebook subset restriction table based on a number of antennas in the adaptive configuration of the antenna array.

9. The apparatus of claim 1, wherein the one or more processors are further configured to receive, from the base station, an indication of the second codebook subset restriction table to use for a number of antennas in the adaptive configuration of the antenna array.

10. An apparatus for wireless communication, comprising:
a transceiver;
a memory configured to store instructions; and
one or more processors communicatively coupled with the memory and the transceiver, wherein the one or more processors are configured to:
transmit, to a user equipment (UE), a configuration indicating a first codebook subset restriction table restricting a set of precoding matrix indicators (PMIs) for which PMI feedback is to be reported for an antenna array; and
receive, from the UE, the PMI feedback for an adaptive configuration of the antenna array based on a second codebook subset restriction table for the adaptive configuration of the antenna array.

11. The apparatus of claim 10, wherein the one or more processors are further configured to transmit, to the UE, the adaptive configuration for the antenna array that indicates to use a number of antennas for wireless communications that is less than all antennas in the antenna array.

12. The apparatus of claim 11, wherein the adaptive configuration indicates reduction of at least one of a first dimension, or a second dimension, of the antenna array.

13. The apparatus of claim 10, wherein the second codebook subset restriction table is generated, based on the first codebook subset restriction table, as a reduced size codebook subset restriction table corresponding to a number of antennas in the adaptive configuration of the antenna array.

14. The apparatus of claim 10, wherein the one or more processors are further configured to transmit, to the UE an indication of the second codebook subset restriction table to use for a number of antennas in the adaptive configuration of the antenna array.

15. The apparatus of claim 10, wherein the one or more processors are further configured to transmit, to the UE, an indication of a number of one or more additional PMIs to disable in generating the second codebook subset restriction table, wherein the number of one or more additional PMIs corresponds to PMIs having a range of table index values that are a function of a second range of first table index values of the first codebook subset restriction table corresponding to PMIs that are restricted in the first codebook subset restriction table.

16. A method for wireless communication at a user equipment (UE), comprising:
receiving, from a base station, a configuration indicating a first codebook subset restriction table restricting a set of precoding matrix indicators (PMIs) for which PMI feedback is to be reported for an antenna array;
generating, based on the configuration, PMI feedback for an adaptive configuration of the antenna array based on a second codebook subset restriction table for the adaptive configuration of the antenna array; and
transmitting the PMI feedback to the base station.

17. The method of claim 16, further comprising receiving, from the base station, the adaptive configuration for the antenna array that indicates to use a number of antennas for wireless communications that is less than all antennas in the antenna array.

18. The method of claim 17, wherein the adaptive configuration indicates reduction of at least one of a first dimension, or a second dimension, of the antenna array.

19. The method of claim 16, wherein the second codebook subset restriction table includes a portion of the first codebook subset restriction table, wherein the portion is based on a number of antennas in the adaptive configuration of the antenna array.

20. The method of claim 16, further comprising generating, based on the first codebook subset restriction table, the second codebook subset restriction table as a reduced size codebook subset restriction table corresponding to a number of antennas in the adaptive configuration of the antenna array.

21. The method of claim 20, wherein generating the second codebook subset restriction table includes restricting a number of PMIs in the second codebook subset restriction table having a range of table index values that are a function of a second range of table index values of the first codebook subset restriction table corresponding to PMIs that are restricted in the first codebook subset restriction table.

22. The method of claim 21, further comprising receiving an indication of the number of PMIs in a configuration from the base station.

23. The method of claim 16, further comprising receiving, from the base station, a configuration indicating a third codebook subset restriction table restricting a set of PMIs for which PMI feedback is to be reported for a reduced antenna array, wherein generating the PMI feedback is based on selecting the first codebook subset restriction table or the third codebook subset restriction table for generating the second codebook subset restriction table based on a number of antennas in the adaptive configuration of the antenna array.

24. The method of claim 16, further comprising receiving, from the base station, an indication of the second codebook subset restriction table to use for a number of antennas in the adaptive configuration of the antenna array.

25. A method for wireless communication at a network, comprising:
transmitting, to a user equipment (UE), a configuration indicating a first codebook subset restriction table restricting a set of precoding matrix indicators (PMIs) for which PMI feedback is to be reported for an antenna array; and
receiving, from the UE, the PMI feedback for an adaptive configuration of the antenna array based on a second codebook subset restriction table for the adaptive configuration of the antenna array.

26. The method of claim 25, further comprising transmitting, to the UE, the adaptive configuration for the antenna array that indicates to use a number of antennas for wireless communications that is less than all antennas in the antenna array.

27. The method of claim 26, wherein the adaptive configuration indicates reduction of at least one of a first dimension, or a second dimension, of the antenna array.

28. The method of claim 25, wherein the second codebook subset restriction table is generated, based on the first codebook subset restriction table, as a reduced size codebook subset restriction table corresponding to a number of antennas in the adaptive configuration of the antenna array.

29. The method of claim 25, further comprising transmitting, to the UE an indication of the second codebook subset restriction table to use for a number of antennas in the adaptive configuration of the antenna array.

30. The method of claim 25, further comprising transmitting, to the UE, an indication of a number of one or more additional PMIs to disable in generating the second codebook subset restriction table, wherein the number of one or more additional PMIs corresponds to PMIs having a range of table index values that are a function of a second range of first table index values of the first codebook subset restriction table corresponding to PMIs that are restricted in the first codebook subset restriction table.
